(19) United States
(12) Patent Application Publication
(10) Pub. No.: US 2024/0288630 A1
(43) Pub. Date: Aug. 29, 2024

(54) OPTICAL FIBER AND OPTICAL FIBER RIBBON

(71) Applicant: SUMITOMO ELECTRIC INDUSTRIES, LTD., Osaka (JP)

(72) Inventors: Noriaki IWAGUCHI, Osaka (JP); Katsushi HAMAKUBO, Osaka (JP); Miho IKEGAWA, Osaka (JP)

(21) Appl. No.: 18/585,262

(22) Filed: Feb. 23, 2024

(30) Foreign Application Priority Data
Feb. 27, 2023 (JP) 2023-028080

(51) Int. Cl. G02B 6/02; C03C 25/1065; G02B 6/44

(52) U.S. Cl. CPC G02B 6/02395; C03C 25/109; G02B 6/4403; C03C 2217/212; C03C 2217/42

(57) ABSTRACT

An optical fiber includes a glass fiber including a core and a cladding, and a first resin layer in contact with the glass fiber and covering the glass fiber. The first resin layer includes a cured product of a resin composition containing a photopolymerizable compound and a photopolymerization initiator, and when the first resin layer is heated from 30° C. to 150° C., a rate of reduction in mass of the first resin layer is 6.0% by mass or less.

### CROSS-REFERENCE TO RELATED APPLICATIONS

This application claims priority based on Japanese Patent Application No. 2023-028080 filed on Feb. 27, 2023, and the entire contents of the Japanese patent application are incorporated herein by reference.

### TECHNICAL FIELD

The present disclosure relates to an optical fiber and an optical fiber ribbon.

### BACKGROUND

In general, an optical fiber includes a coating resin layer for protecting a glass fiber, which transmits optical signals. It is known that the coating resin layer has a two-layer structure including, for example, a primary resin layer in contact with the glass fiber and a secondary resin layer formed on the outer peripheral surface of the primary resin layer (for example, refer to JP S58-211707 A).

### SUMMARY

An optical fiber according to an aspect of the present disclosure includes a glass fiber including a core and a cladding, and a first resin layer in contact with the glass fiber and covering the glass fiber. The first resin layer includes a cured product of a resin composition containing a photopolymerizable compound and a photopolymerization initiator, and when the first resin layer is heated from 30° C. to 150° C., a rate of reduction in mass of the first resin layer is 6.0% by mass or less.

### BRIEF DESCRIPTION OF THE DRAWINGS

FIG. 1 is a schematic cross-sectional view showing an example of an optical fiber according to an embodiment.

FIG. 2 is a schematic cross-sectional view showing another example of an optical fiber according to an embodiment.

FIG. 3 is a schematic cross-sectional view showing an example of an optical fiber ribbon according to an embodiment.

### DETAILED DESCRIPTION

In recent years, in data center applications, there has been an increasing demand for high-density cables with an increased packing density of optical fibers. As the packing density of optical fibers in a cable increases, it is advantageous to reduce the outer diameter of the optical fibers. In the case of the optical fiber having the coating resin layer of the conventional two-layer structure, when the optical fiber is made thinner or the manufacturing speed of the optical fiber is increased, the eccentricity of the optical fiber tends to be deteriorated, and thus the microbend resistance of the optical fiber may be reduced. It is conceivable to improve the microbend resistance of the optical fiber by adjusting the Young's modulus of the coating resin layer, for example, by decreasing the Young's modulus of the primary resin layer, but in this case, it may be difficult to achieve both a sufficient degree of cure and coating removability of the coating resin layer.

It is an object of the present disclosure to provide an optical fiber and an optical fiber ribbon including a coating resin layer having a sufficient degree of cure and excellent coating removability.

### DESCRIPTION OF EMBODIMENTS OF PRESENT DISCLOSURE

First, the contents of embodiments of the present disclosure will be listed and explained.

(1) An optical fiber according to an embodiment of the present disclosure includes a glass fiber including a core and a cladding, and a first resin layer in contact with the glass fiber and covering the glass fiber. The first resin layer includes a cured product of a resin composition containing a photopolymerizable compound and a photopolymerization initiator, and when the first resin layer is heated from 30° C. to 150° C., a rate of reduction in mass (hereinafter, also referred to as a “rate of reduction in mass during heating”) of the first resin layer is 6.0% by mass or less.

The optical fiber according to the present disclosure, by including the first resin layer having a single-layer structure as described above, can provide an optical fiber including a coating resin layer having a sufficient degree of cure and excellent coating removability.

(2) According to the above (1), the first resin layer may have a Young's modulus of 1 MPa to 600 MPa at 23° C. from the viewpoints of the degree of cure and the coating removability.

(3) According to the above (1) or (2), a content of a urethane (meth)acrylate compound in the resin composition may be 20% by mass or less based on a total amount of the resin composition from the viewpoint of suppressing mass reduction during heating.

(4) According to any one of the above (1) to (3), the photopolymerizable compound may include an alkylene oxide-modified di(meth)acrylate having a bisphenol skeleton from the viewpoint of suppressing mass reduction during heating.

(5) According to any one of the above (1) to (4), the photopolymerization initiator may include an α-hydroxyacetophenone compound from the viewpoint of suppressing mass reduction during heating.

(6) According to the above (5), a content of the α-hydroxyacetophenone compound in the resin composition may be 0.5% by mass or more based on a total amount of the resin composition from the viewpoint of suppressing mass reduction during heating.

(7) According to any one of the above (1) to (6), the optical fiber may further include a colored layer covering the first resin layer from the viewpoint of identifiability of the optical fiber.

(8) According to the above (7), the colored layer may have a thickness of 2 μm to 14 μm from the viewpoints of the identifiability and the coating removability of the optical fiber and from the viewpoint of reducing the tensile stress acting on the first resin layer.

(9) According to the above (7) or (8), the colored layer may contain titanium oxide particles from the viewpoint of identifiability of the optical fiber.

(10) According to any one of the above (1) to (9), the glass fiber may include a plurality of the cores from the viewpoint of a high-density cable.

(11) According to the above (10), the glass fiber may have an outer diameter of 170 μm to 190 μm from the viewpoints of mass productivity and cost.

(12) An optical fiber ribbon according to an embodiment of the present disclosure includes a plurality of the optical fibers according to any one of the above (1) to (11) arranged in parallel, and a connecting resin layer for coating and connecting the plurality of the optical fibers. This makes it possible to provide an optical fiber ribbon including an optical fiber having a coating resin layer having a sufficient degree of cure and excellent coating removability.

### Details of Embodiments of Present Disclosure

Specific examples of an optical fiber and an optical fiber ribbon according to the embodiments of the present disclosure will be described with reference to the drawings as necessary. The present disclosure is not limited to these examples, but is defined by the claims, and is intended to include all modifications within the meaning and scope equivalent to the claims. In the following description, the same elements are denoted by the same reference numerals in the description of the drawings, and redundant description will be omitted. In the embodiments of the present disclosure, a (meth)acrylate means an acrylate or a meth acrylate corresponding thereto, and other similar expressions such as (meth)acrylic acid are in the same way.

(Optical Fiber) An optical fiber according to an embodiment includes a glass fiber including a core and a cladding, and a first resin layer in contact with the glass fiber and covering the glass fiber. The first resin layer has a single-layer structure.

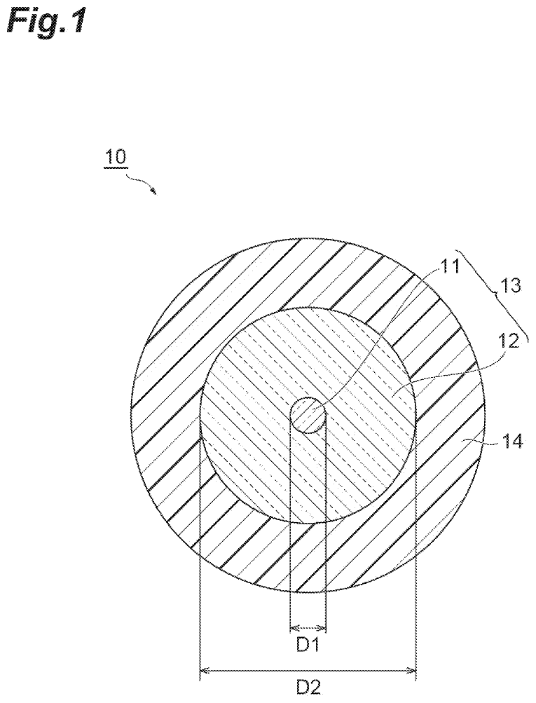

FIG. 1 is a schematic cross-sectional view showing an example of an optical fiber according to the embodiment. An optical fiber 10 includes a glass fiber 13 including a core 11 and a cladding 12, and a first resin layer 14 provided on the outer peripheral surface of glass fiber 13.

Cladding 12 surrounds core 11. Core 11 and cladding 12 mainly contain glass such as quartz glass, and for example, germanium-doped quartz glass or pure quartz glass can be used for core 11, and pure quartz glass or fluorine-doped quartz glass can be used for cladding 12.

In FIG. 1, for example, an outer diameter (D2) of glass fiber 13 is 100 μm to 125 μm, and a diameter (D1) of core 11 included in glass fiber 13 is 7 μm to 15 μm. A thickness of first resin layer 14 may be 20 μm to 70 μm, 22 μm to 65 μm, 22 μm to 45 μm, or 22 μm to 30 μm. An outer diameter of optical fiber 10 may be 150 μm to 250 μm, 170 μm to 250 μm, 170 μm to 220 μm, or 170 μm to 190 μm.

When glass fiber 13 has the outer diameter (D2) of about 125 μm, the thickness of first resin layer 14 may be 60 μm to 70 μm, or 22 μm to 63 μm. When glass fiber 13 has the outer diameter (D2) of about 100 μm, the thickness of first resin layer 14 may be 22 μm to 45 μm.

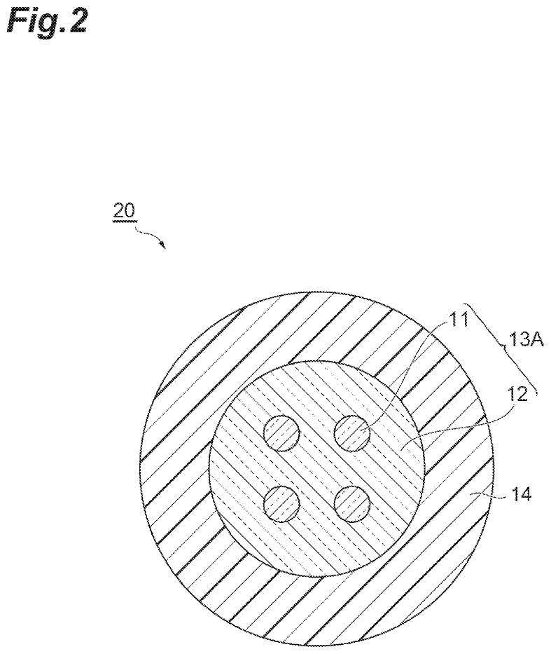

Although FIG. 1 shows an optical fiber including a glass fiber having one core, the optical fiber according to the embodiment may be an optical fiber including a glass fiber having a plurality of cores (hereinafter, also referred to as a “multi-core optical fiber”). The multi-core optical fiber is an optical fiber in which a plurality of cores extending in a fiber axial direction are covered with a common cladding. In the multi-core optical fiber, the number of cores included in the glass fiber may be two or more, three or more, four or more, five or more, or six or more. In the multi-core optical fiber, the materials of the plurality of cores may be the same or different. As an example of the multi-core optical fiber, FIG. 2 shows an optical fiber 20 including a glass fiber 13A having four cores 11. In FIG. 2, the outer diameter of glass fiber 13A is, for example, 170 μm to 190 μm from the viewpoints of mass productivity and cost, and the thickness of first resin layer 14 is, for example, 22 μm to 45 μm.

First resin layer 14 includes a cured product of a resin composition (hereinafter, also referred to as “resin composition A”) containing a photopolymerizable compound and a photopolymerization initiator. The resin composition A is an ultraviolet curable resin composition.

It is better for the photopolymerizable compound not to include a urethane (meth)acrylate compound from the viewpoint of suppressing mass reduction during heating. When the urethane (meth)acrylate compound is included, the content may be 20% by mass or less, 15% by mass or less, 10% by mass or less, or 5% by mass or less based on the total amount of the resin composition A.

The urethane (meth)acrylate compound may be a compound obtained by reacting a polyol compound, a polyisocyanate compound, and a hydroxyl group-containing (meth)acrylate compound. Examples of the polyol compound include polytetramethylene glycol, polypropylene glycol, and a bisphenol A-ethylene oxide adduct diol. From the viewpoint of adjusting the Young's modulus, a number average molecular weight (Mn) of the polyol compound may be 300 to 8000, 400 to 5000, or 500 to 4000. Examples of the polyisocyanate compound include 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate compound includes, 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol (meth)acrylate.

An organotin compound is generally used as a catalyst for synthesizing the urethane (meth)acrylate compound. Examples of the organotin compound include dibutyltin dilaurate, dibutyltin diacetate, dibutyltin maleate, dibutyltin bis(2-ethylhexyl mercaptoacetate), dibutyltin bis(isooctyl mercaptoacetate), and dibutyltin oxide. From the viewpoint of availability or catalyst performance, for example, dibutyltin dilaurate or dibutyltin diacetate may be used as the organotin compound.

Lower alcohol having 5 or less carbon atoms may be used in the synthesis of the urethane (meth)acrylate compound. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2, 2-dimethyl-1-propanol.

The photopolymerizable compound may include an alkylene oxide-modified di(meth) acrylate having a bisphenol skeleton (hereinafter, also referred to as “alkylene oxide-modified di(meth)acrylate”) having excellent curability from the viewpoint of suppressing mass reduction during heating.

The alkylene oxide-modified di(meth)acrylate may have at least one selected from the group consisting of an ethylene oxide (EO) chain and a propylene oxide (PO) chain from the viewpoint of adjusting Young's modulus. The ethylene oxide chain can be represented by “(EO) n”, and the propylene oxide chain can be represented by “(PO) n”. The “n” is an integer of 1 or more, may be 2 or more or 3 or more, and may be 40 or less, 35 or less, or 30 or less.

The alkylene oxide-modified di(meth)acrylate may have a bisphenol A skeleton from the viewpoint of the degree of cure. Examples of the alkylene oxide-modified di(meth)acrylate having a bisphenol A skeleton include EO-modified di(meth)acrylate of bisphenol A, PO-modified di(meth)acrylate of bisphenol A, and EO/PO-modified di(meth)acrylate of bisphenol A. The alkylene oxide-modified di(meth)acrylate may include EO modified di(meth)acrylate of bisphenol A.

The content of the alkylene oxide-modified di(meth)acrylate may be 25% by mass to 85% by mass, 30% by mass to 80% by mass, or 30% by mass to 75% by mass based on the total amount of the resin composition A, from the viewpoint of suppressing mass reduction during heating.

The photopolymerizable compound may include an epoxy di(meth)acrylate having a bisphenol skeleton (hereinafter, also referred to as “epoxy di(meth)acrylate”) from the viewpoint of adjusting Young's modulus. As the epoxy di(meth)acrylate, a reaction product of a diglycidyl ether compound having a bisphenol skeleton and a compound having a (meth)acryloyl group such as (meth)acrylic acid can be used.

Examples of the epoxy di(meth)acrylate include a (meth)acrylic acid adduct of bisphenol A-diglycidyl ether, a (meth)acrylic acid adduct of bisphenol AF-diglycidyl ether, and a (meth)acrylic acid adduct of bisphenol F-diglycidyl ether.

The content of the epoxy di(meth)acrylate may be 55% by mass or less, 45% by mass or less, 35% by mass or less, 25% by mass or less, 15% by mass or less, 5% by mass or less, or 0% by mass based on the total amount of the resin composition A, from the viewpoint of adjusting the Young's modulus.

The photopolymerizable compound may further include, a photopolymerizable compound (hereinafter, also referred to as a “monomer”) other than the urethane (meth)acrylate compound, alkylene oxide-modified di(meth)acrylate, and epoxy di(meth)acrylate. As the monomer, for example, a monofunctional monomer having one polymerizable group or a polyfunctional monomer having two or more polymerizable groups can be used. The monomers may be used alone or in combination of two or more kinds thereof.

Examples of the monofunctional monomer include methyl (meth)acrylate-based monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxydiethylene glycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenol ethylene oxide-modified (meth)acrylate, nonylphenoxypolyethylene glycol (meth)acrylate, isobornyl (meth)acrylate; carboxyl group-containing monomers such as (meth) acrylic acid, (meth) acrylic acid dimers, carboxyethyl (meth)acrylate, carboxypentyl (meth)acrylate, ω-carboxy-polycaprolactone (meth)acrylate; heterocycle-containing (meth)acrylate such as N-acryloyl morpholine, N-vinyl pyrrolidone, N-vinylcaprolactam, N-acryloylpiperidine, N-methacryloylpiperidine, N-acryloylpyrrolidine, 3-(3-pyridyl) propyl (meth)acrylate, cyclic trimethylolpropane formal acrylate; maleimide-based monomers such as maleimide, N-cyclohexylmaleimide, N-phenylmaleimide; N-substituted amide-based monomers such as (meth)acrylamide, N,N-dimethyl(meth)acrylamide, N,N-diethyl(meth)acrylamide, N-hexyl(meth)acrylamide, N-methyl(meth)acrylamide, N-ethyl(meth)acrylamide, N-butyl(meth)acrylamide, N-methylol(meth)acrylamide, N-methylolpropane(meth)acrylamide; (meth)acrylic acid aminoalkyl-based monomers such as (meth)acrylic acid aminoethyl, (meth)acrylic acid aminopropyl, (meth)acrylic acid N,N-dimethylaminoethyl, (meth)acrylic acid tert-butylaminoethyl; succinimide-based monomers such as N-(meth)acryloyloxymethylene succinimide, N-(meth)acryloyl-6-oxyhexamethylene succinimide, N-(meth)acryloyl-8-oxyoctamethylene succinimide.

Examples of the polyfunctional monomer include ethylene glycol di(meth)acrylate, polyethylene glycol di(meth)acrylate, polypropylene glycol di(meth)acrylate, neopentyl glycol di(meth)acrylate, tripropylene glycol di(meth)acrylate, tetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyl di(meth)acrylate, 3-ethyl-1,8-octanediol di(meth)acrylate, trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris [(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate.

The photopolymerization initiator can be appropriately selected from known radical photopolymerization initiators and used. The photopolymerization initiator may be used alone or as a mixture of two or more.

The photopolymerization initiator may be an α-hydroxyacetophenone compound from the viewpoint of suppressing mass reduction during heating. The resin composition A can improve surface curability and suppress mass reduction during heating of the resin layer to be formed by using the α-hydroxyacetophenone compound as the photopolymerization initiator. Examples of the α-hydroxyacetophenone compound include 1-(4-isopropylphenyl)-2-hydroxy-2-methylpropan-1-one, 1-hydroxycyclohexyl phenyl ketone (Omnirad 184, produced by IGM Resins B.V.), 2-hydroxy-2-methyl-1-phenylpropanone (Omnirad 1173, produced by IGM Resins B.V.), and 1-[4-(2-hydroxyethoxyl)-phenyl]-2-hydroxy-2-methylpropanone (Omnirad 2959, produced by IGM Resins B.V.).

The content of the α-hydroxyacetophenone compound may be 0.5% by mass or more, 1.0% by mass or more, 1.5% by mass or more, 2.0% by mass or more, 2.5% by mass or more, 3.0% by mass or more, 3.5% by mass or more, or 4.0% by mass or more, based on the total amount of the resin composition A, from the viewpoint of suppressing mass reduction during heating. The content of the α-hydroxyacetophenone compound may be 10.0% by mass or less based on the total amount of the resin composition A. From the same viewpoint, the content of the α-hydroxyacetophenone compound may be 30% by mass or more, 40% by mass or more, 50% by mass or more, 60% by mass or more, 70% by mass or more, or 80% by mass or more based on the total amount of the photopolymerization initiator.

As the photopolymerization initiator, a photopolymerization initiator other than the α-hydroxyacetophenone compound may be used. Examples of such photopolymerization initiators include 2,2-dimethoxy-2-phenyl acetophenone, bis(2,6-dimethoxybenzoyl)-2,4,4-trimethylpentylphosphine oxide, 2-methyl-1-[4-(methylthio)phenyl]-2-morpholino-propan-1-one (Omnirad 907, produced by IGM Resins B.V.), 2,4 6-trimethylbenzoyldiphenylphosphine oxide (Omnirad TPO, produced by IGM Resins B.V.), and bis(2,4,6-trimethylbenzoyl)phenylphosphine oxide (Omnirad 819, produced by IGM Resins B.V.).

The content of the photopolymerization initiator may be 1.5% by mass or more, 2.0% by mass or more, 3.0% by mass or more, 4.0% by mass or more, 4.5% by mass or more, or 5.0% by mass or more, based on the total amount of the resin composition A, from the viewpoint of suppressing mass reduction during heating. The content of the photopolymerization initiator may be 12.0% by mass or less based on the total amount of the resin composition A.

The resin composition A may further contain other components in addition to the photopolymerizable compound and the photopolymerization initiator. Examples of the other components include a silane coupling agent, a photoacid generator, a leveling agent, a antifoaming agent, an antioxidant, and a sensitizer.

The silane coupling agent is not particularly limited as long as it does not hinder the curing of the resin composition. Examples of the silane coupling agent include tetramethyl silicate, tetraethyl silicate, mercaptopropyltrimethoxysilane, vinyltrichlorosilane, vinyltriethoxysilane, vinyltris(β-methoxy-ethoxy)silane, β-(3,4-epoxycyclohexyl)-ethyltrimethoxysilane, dimethoxydimethylsilane, diethoxydimethylsilane, 3-acryloxypropyltrimethoxysilane, 3-glycidoxypropyltrimethoxysilane, 3-glycidoxypropylmethyldiethoxysilane, 3-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-3-aminopropyltrimethoxysilane, 3-chloropropyltrimethoxysilane, 3-mercaptopropyltrimethoxysilane, 3-aminopropyltrimethoxysilane, bis-[3-(triethoxysilyl)propyl]tetrasulfide, bis-[3-(triethoxysilyl)propyl]disulfide, γ-trimethoxysilylpropyldimethylthiocarbamyl tetrasulfide, and γ-trimethoxysilylpropylbenzothiazyl tetrasulfide.

As the photoacid generator, an onium salt having a structure of A⁺B⁻ may be used. Examples of the photoacid generator include sulfonium salts such as UVACURE1590 (produced by Daicel-Cytec), CPI-100P, 110P, 210S (produced by San-Apro Ltd.), and iodonium salts such as Omnicat 250 (produced by IGM Resins B.V.), WPI-113 (produced by FUJIFILM WAKO PURE CHEMICAL CORP.), and Rp-2074 (produced by Rhodia Japan).

When first resin layer 14 is heated from 30° C. to 150° C., the rate of reduction in mass of first resin layer 14 is 6.0% by mass or less, or may be 5.0% by mass or less, 4.5% by mass or less, 4.0% by mass or less, 3.5% by mass or less, 3.0% by mass or less, 2.5% by mass or less, or 2.0% by mass or less. The rate of reduction in mass during heating can be calculated by the method described in Examples. When the rate of reduction in mass during heating is within the above range, first resin layer 14 has a sufficient degree of cure and is excellent in coating removability. When the rate of reduction in mass of first resin layer 14 during heating exceeds 6.0% by mass, the degree of cure is insufficient, and thus first resin layer 14 is easily damaged and is easily disconnected during drawing. When the rate of reduction in mass during heating is within the above range, an optical fiber having excellent external damage resistance and capable of preventing disconnection during drawing can be obtained.

From the viewpoints of the degree of cure and the coating removability, the Young's modulus of first resin layer 14 at 23° C. may be 1 MPa or more, or may be 600 MPa or less, 500 MPa or less, or 300 MPa or less. The Young's modulus can be obtained by measurement according to the method described in Examples.

First resin layer 14 may further include a colored layer on the outer circumferential surface thereof in order to identify the optical fiber. The optical fiber having the colored layer is also referred to as a colored optical fiber. A thickness of the colored layer may be 2 μm or more, 3 μm or more, 4 μm or more, or 5 μm or more from the viewpoints of the identifiability and the coating removability of the optical fiber, and may be 14 μm or less, 12 μm or less, 10 μm or less, or 7 μm or less from the viewpoint of reducing the tensile stress acting on the first resin layer. The thickness of the colored layer may be 2 μm to 14 μm, 3 μm to 12 μm, 4 μm to 10 μm, or 5 μm to 7 μm.

The colored layer may contain a pigment from the viewpoint of improving the identifiability of the optical fiber. Examples of pigments include inorganic pigments such as colored pigments such as carbon black, titanium oxide, and zinc oxide, magnetic powders such as γ-Fe₂O₃, mixed crystals of γ-Fe₂O₃ and γ-Fe₃O₄, CrO₂, cobalt ferrite, cobalt coated iron oxide, barium ferrite, Fe—Co, and Fe—Co—Ni, MIO, zinc chromate, strontium chromate, aluminum tripolyphosphate, zinc, alumina, glass, mica; and organic pigments such as azo-based pigments, phthalocyanine-based pigments, dye lake pigments. The pigment may be subjected to various treatments such as surface modification and composite pigment formation. The colored layer may contain titanium oxide particles from the viewpoint of identification.

The colored layer can be formed using, for example, a resin composition (hereinafter, also referred to as “resin composition B”) containing a photopolymerizable compound, a photopolymerization initiator, and titanium oxide particles. The resin composition B is an ultraviolet curable resin composition. Examples of the photopolymerizable compound and the photopolymerization initiator contained in the resin composition B include the photopolymerizable compound and the photopolymerization initiator contained in the resin composition A. The composition of the resin composition B is preferably close to the composition of the resin composition A from the viewpoint of adhesion between the colored layer and the first resin layer. For example, the content of the urethane (meth)acrylate compound in the resin composition B may be 20% by mass or less, 15% by mass or less, 10% by mass or less, or 5% by mass or less based on the total amount of the resin composition B.

The titanium oxide particles may be surface-treated titanium oxide particles from the viewpoint of dispersibility in the resin composition. The surface-treated titanium oxide particles are particles obtained by subjecting titanium oxide to a surface treatment with an inorganic substance.

Examples of the inorganic substance used for the surface treatment include aluminum oxide, silicon dioxide, and zirconium dioxide. When the surface-treated titanium oxide particle has a surface treatment layer containing at least one selected from the group consisting of aluminum oxide, silicon dioxide, and zirconium dioxide, the dispersibility can be further improved. The surface treatment layer may be formed on at least a part of the surface of the titanium oxide particle, or may be formed on the entire surface of the titanium oxide particle. The surface treatment layer is formed by surface treatment of titanium oxide particles.

An amount of the surface treatment layer in the surface-treated titanium oxide particle may be 1% by mass or more, 1.5% by mass or more, or 2% by mass or more from the viewpoint of further improving dispersibility, and may be 10% by mass or less, 9% by mass or less, or 8% by mass or less from the viewpoint of enhancing hiding power. The amount of the surface treatment layer can be calculated by measuring the amounts of the titanium element and the inorganic elements other than titanium contained in the surface-treated titanium oxide particle by using inductively coupled mass spectrometry (ICP-MS).

An average primary particle diameter of the surface-treated titanium oxide particles may be 300 nm or less, 295 nm or less, or 290 nm or less, from the viewpoint of improving the lateral pressure resistance of the first resin layer. The average primary particle diameter of the surface-treated titanium oxide particles may be 100 nm or more, 150 nm or more, or 200 nm or more, and 200 nm to 300 nm, from the viewpoint of enhancing the hiding power. The average primary particle diameter can be determined by, for example, image analysis of an electron micrograph, a light scattering method, a BET method, or the like.

The content of the titanium oxide particles may be 2% by mass or more, 2.5% by mass or more, or 3% by mass or more based on the total amount of the resin composition B from the viewpoint of identifiability, and may be 20% by mass or less, 15% by mass or less, 10% by mass or less, or 8% by mass or less from the viewpoint of curability of the resin composition B.

The Young's modulus of the colored layer may be 2000 MPa or less at 23° C. from the viewpoint of reducing the tensile stress acting on the first resin layer and from the viewpoint of suppressing the colored layer from becoming brittle, and may be 300 MPa or more at 23° C. or 500 MPa or more from the viewpoint of coating removability.

The optical fiber according to the embodiment can be manufactured by a method that includes the process of applying the resin composition A to the outer surface of a glass fiber and then curing the resin composition A by irradiating ultraviolet rays to form a first resin layer.

### (Optical Fiber Ribbon)

An optical fiber ribbon can be manufactured using the optical fiber according to the embodiment. The optical fiber ribbon according to the embodiment includes a plurality of optical fibers that are arranged in parallel, and a connecting resin layer for coating and connecting the plurality of optical fibers.

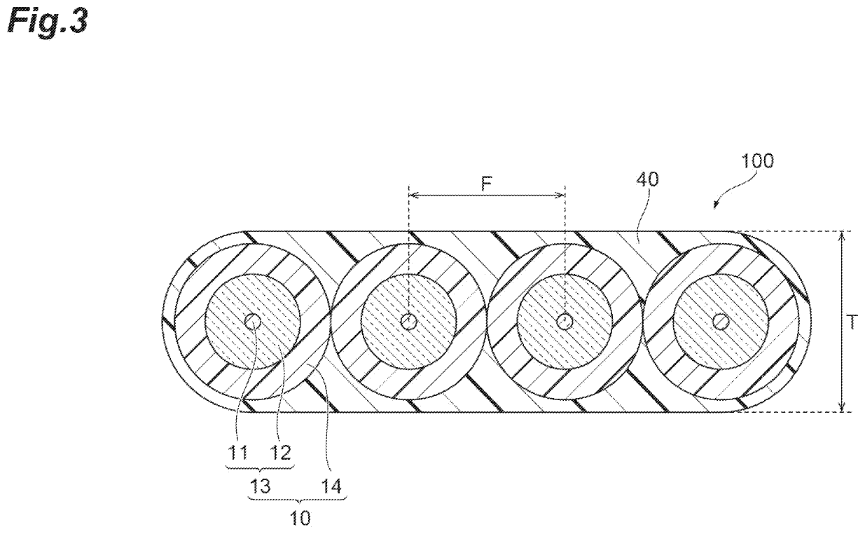

FIG. 3 is a schematic cross-sectional view of an example of an optical fiber ribbon according to an embodiment. In FIG. 3, an optical fiber ribbon 100 includes a plurality of optical fibers 10 arranged in parallel and a connecting resin layer 40 in which the plurality of optical fibers 10 are coated with a ribbon resin and connected to each other. In FIG. 3, four optical fibers 10 are shown as an example, but the number of optical fibers is not particularly limited.

Optical fibers 10 may be integrated in a state of being in contact with each other and being parallel to each other, or a part or all of optical fibers 10 may be integrated in a state of being parallel to each other at regular intervals. A center-to-center distance F between adjacent optical fibers 10 may be 220 μm to 280 μm. When the center-to-center distance is 220 μm to 280 μm, the optical fibers can be easily placed in the existing V-grooves, and an optical fiber ribbon having excellent batch fusion property can be obtained. A thickness T of optical fiber ribbon 100 may be 164 μm to 310 μm, although depending on the outer diameter of optical fiber 10. The ribbon resin is not particularly limited, and the connecting resin layer may include for example, an urethane (meth)acrylate or the like.

### Examples

The present disclosure will be described in more detail below by showing the results of evaluation tests using Examples and Comparative Examples according to the present disclosure. It is noted that, the present invention is not limited to these examples.

### [Resin Composition for First Resin Layer]

The components shown in Table 1 were mixed in accordance with the amounts (parts by mass) shown in the table to prepare resin compositions A. Test examples 1 to 6 correspond to the Examples, and test examples 7 and 8 correspond to the Comparative Examples. Details of each component shown in Table 1 are as follows.

### (Photopolymerizable Compound)

A1: EO-modified diacrylate of bisphenol A (EO number: 30)
A2: bisphenol A epoxy diacrylate
A3: EO-modified acrylate of nonylphenol
A4: tripropylene glycol diacrylate
A5: urethane acrylate (Mn: about 1200) obtained by reacting polypropylene glycol having a number average molecular weight of 600, 2,4-tolylene diisocyanate, and 2-hydroxyethyl acrylate (Photopolymerization Initiator)
B1: 2,4,6-trimethylbenzoyldiphenylphosphine oxide (Omnirad TPO)
B2: 1-hydroxycyclohexyl phenyl ketone (Omnirad 184)

### [Resin Composition for Colored Layer]

A resin composition B was obtained by mixing 60 parts by mass of bisphenol A epoxy diacrylate, 29 parts by mass of EO-modified diacrylate of bisphenol A, 1 part by mass of 2,4,6-trimethylbenzoyldiphenylphosphine oxide (Omnirad TPO), 4 parts by mass of 1-hydroxycyclohexyl phenyl ketone (Omnirad 184), 1 part by mass of ether-modified silicone compound, and 5 parts by mass of surface-treated titanium oxide particles. The surface-treated titanium oxide particles were titanium oxide particles having surface treatment layers containing aluminum oxide (Al₂O₃), and had the average primary particle diameters of 200 nm to 300 nm. The amount of Al₂O₃ calculated by ICP-MS measurement was 2% by mass.

### [Resin Composition for Ribbon]

A urethane acrylate a obtained by reacting 1 mol. of bisphenol A-ethylene oxide adduct diol, 2 mol. of tolylene diisocyanate, and 2 mol. of hydroxyethyl acrylate, and a urethane acrylate b obtained by reacting 1 mol. of polytetramethylene glycol, 2 mol. of tolylene diisocyanate, and 2 mol. of hydroxyethyl acrylate were prepared. A resin composition R was obtained by mixing 18 parts by mass of the urethane acrylate a, 10 parts by mass of the urethane acrylate b, 15 parts by mass of tricyclodecane diacrylate, 10 parts by mass of N-vinyl pyrrolidone, 10 parts by mass of isobornyl acrylate, 5 parts by mass of bisphenol A-ethylene oxide adduct diol diacrylate, 0.7 parts by mass of 2-methyl-1-[4-(methylthio)phenyl]-2-morpholino-propan-1-one (Omnirad 907), and 1.3 parts by mass of 2,4,6-trimethylbenzoyldiphenylphosphine oxide (Omnirad TPO).

### [Production of Optical Fiber]

The resin composition A was applied to the outer circumferential surface of a glass fiber having a diameter of 125 μm and constituted by a core and a cladding, and the resin composition was cured by irradiation with ultraviolet rays to form a first resin layer (hereinafter, also referred to as “resin layer A”) having a thickness of 22.5 μm, thereby producing an optical fiber having a diameter of 170 μm.

### (Young's Modulus)

A pipe-shaped resin layer A (length: 50 mm or more) obtained by immersing the optical fiber in a solution (ethanol:acetone=3:7) and extracting the glass fiber was used to conduct a tensile test at 23° C. (gauge length: 25 mm), and the result was determined from the 2.5% secant value. The higher the Young's modulus is, the higher the degree of cure of the resin layer A tends to be.

### (Rate of Reduction in Mass)

Only the resin layer A was extracted from the optical fiber, and the obtained resin layer A was heated from 30° C. to 150° C. at a rate of 20° C./min in a nitrogen gas atmosphere by using STA449 F3 Jupiter (registered trade mark, produced by NETZSCH), and the weight of the resin layer A at 150° C. was measured. The rate of reduction in mass was calculated by the following formula.

Rate of reduction in mass (% by mass)=[mass reduction amount of resin layer A]/[mass of resin layer A at 30° C.]×100

Here, the mass reduction amount of the resin layer A is the difference between the mass of the resin layer A at 30° C. and the mass of the resin layer A at 150° C.

### [Production of Colored Optical Fiber]

While the optical fiber was again fed out by a coloring machine after once wound, a colored layer having a thickness of 5 μm was formed on the outer peripheral surface of the resin layer A using the resin composition B, and an optical fiber with the colored layer and having a diameter of 180 μm was produced.

### [Production of Optical Fiber Ribbon]

A 10 μm-thick connecting resin layer was formed around the 12 parallel arranged colored optical fibers using resin composition R to produce an optical fiber ribbon.

### (Coating Removability)

The optical fiber ribbon was heated at 95° C. for 5 seconds, and then the coating of the resin layer was removed from the optical fiber ribbon using a hot jacket remover “JR-6+” produced by Sumitomo Electric Industries, Ltd. The coating removability was evaluated according to the following criteria.
A: No coating residue of the resin layer was present on the glass fiber, and no disconnection of the glass fiber was observed.
B: The coating residue of the resin layer remaining on the glass fiber could be easily wiped off with a Kimwipe moistened with ethanol.
C: The coating residue of the resin layer remaining on the glass fiber could not be wiped off with a Kimwipe moistened with ethanol, or there were disconnection of the glass fiber.

TABLE 1

| | Test Examples | | | | | | | |
|---|---|---|---|---|---|---|---|---|
| | 1 | 2 | 3 | 4 | 5 | 6 | 7 | 8 |
| A1 | 30 | 35 | 50 | 65 | 70 | 70 | 70 | 70 |
| A2 | 55 | 50 | 35 | 25 | 5 | — | — | — |
| A3 | — | — | — | — | 20 | 8 | — | 8 |
| A4 | 10 | 10 | 10 | 5 | — | — | — | — |
| A5 | — | — | — | — | — | 20 | 25 | 20.6 |
| B1 | 1 | 1 | 1 | 1 | 1 | 1 | 1 | 1 |
| B2 | 4 | 4 | 4 | 4 | 4 | 1 | 4 | 0.4 |
| Young's | 500 | 300 | 100 | 20 | 5 | 1.1 | 0.8 | 0.8 |
| Modulus(Mpa) | | | | | | | | |
| Rate of | 2.0 | 3.0 | 3.5 | 4.0 | 4.5 | 5.0 | 8.0 | 7.5 |
| Reduction in | | | | | | | | |
| mass(mass %) | | | | | | | | |
| Coating | A | A | A | A | B | B | C | C |
| Removability | | | | | | | | |

What is claimed is:

1. An optical fiber comprising:
a glass fiber including a core and a cladding; and
a first resin layer in contact with the glass fiber and covering the glass fiber,
wherein the first resin layer includes a cured product of a resin composition containing a photopolymerizable compound and a photopolymerization initiator, and
when the first resin layer is heated from 30° C. to 150° C., a rate of reduction in mass of the first resin layer is 6.0% by mass or less.

2. The optical fiber according to claim 1, wherein the first resin layer has a Young's modulus of 1 MPa to 600 MPa at 23° C.

3. The optical fiber according to claim 1, wherein a content of a urethane (meth)acrylate compound in the resin composition is 20% by mass or less based on a total amount of the resin composition.

4. The optical fiber according to claim 1, wherein the photopolymerizable compound includes an alkylene oxide-modified di(meth)acrylate having a bisphenol skeleton.

5. The optical fiber according to claim 1, wherein the photopolymerization initiator includes an α-hydroxyacetophenone compound.

6. The optical fiber according to claim 5, wherein a content of the α-hydroxyacetophenone compound in the resin composition is 0.5% by mass or more based on a total amount of the resin composition.

7. The optical fiber according to claim 1, further comprising a colored layer covering the first resin layer.

8. The optical fiber according to claim 7, wherein the colored layer has a thickness of 2 μm to 14 μm.

9. The optical fiber according to claim 7, wherein the colored layer contains titanium oxide particles.

10. The optical fiber according to claim 1, wherein the glass fiber includes a plurality of the cores.

11. The optical fiber according to claim 10, wherein the glass fiber has an outer diameter of 170 μm to 190 μm.

12. An optical fiber ribbon comprising:
a plurality of the optical fibers according to claim 1 arranged in parallel; and
a connecting resin layer for coating and connecting the plurality of the optical fibers.
